(19) United States
(12) Patent Application Publication
(10) Pub. No.: US 2025/0286049 A1
(43) Pub. Date: Sep. 11, 2025

(54) ELECTROCHEMICAL DEVICE AND ELECTRONIC DEVICE

(71) Applicant: Ningde Amperex Technology Limited, Ningde City, Fujian Province (CN)

(72) Inventors: Lilan Zhang, Ningde City (CN); Xiexue Peng, Ningde City (CN); Junfei Liu, Ningde City (CN); Chao Tang, Ningde City (CN)

(73) Assignee: Ningde Amperex Technology Limited, Ningde City, Fujian Province (CN)

(21) Appl. No.: 18/896,125

(22) Filed: Sep. 25, 2024

(30) Foreign Application Priority Data
Sep. 25, 2023 (CN) 202311243259.4

(51) Int. Cl. H01M 4/36; H01M 4/02; H01M 4/505; H01M 4/525; H01M 4/58; H01M 10/0525; H01M 10/0567

(52) U.S. Cl. CPC H01M 4/366; H01M 4/364; H01M 4/505; H01M 4/525; H01M 4/5825; H01M 10/0525; H01M 10/0567; H01M 2004/021; H01M 2004/028

(57) ABSTRACT

An electrochemical device includes a positive electrode plate and an electrolyte. The electrolyte includes a compound represented by Formula I:

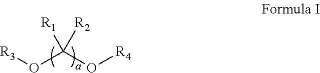

where a is an integer from 1 to 5, the compound represented by Formula I contains at least 4 fluorine atoms, based on a total mass of the electrolyte, a mass percentage of the compound represented by Formula I in the electrolyte is A %, and 7≤A≤72. The positive electrode plate includes a positive current collector, a first material layer and a second material layer, the first material layer is disposed between the positive current collector and the second material layer, a coating mass of the first material layer is x mg over an area of 1540.25 mm², a coating mass of the second material layer is y mg over an area of 1540.25 mm², and 15.4≤y/x≤2530.

### CROSS REFERENCE TO THE RELATED APPLICATIONS

This application claims the benefit of priority from the Chinese Patent Application No. 202311243259.4, filed on Sep. 25, 2023, the entire content of which is incorporated herein by reference.

### TECHNICAL FIELD

This application relates to the field of electrochemical energy storage, and in particular, to an electrochemical device and an electronic device.

### BACKGROUND

With the wide application of electrochemical devices (e.g., lithium-ion batteries) in various types of electronic products, users have put forward higher and higher requirements for the performance of the electrochemical devices, especially the safety performance. For example, the temperature of the electrochemical devices rises abnormally under abnormal usage conditions, such as overcharging, overheating, impact and short circuit, which triggers a series of internal chemical reactions and causes flatulence of the electrochemical devices, and at the same time, these reactions will release a large amount of heat, which will further increase the temperature of the whole electrochemical devices and cause combustion or explosion. Therefore, further improvement is urgently needed to meet the increasing demands for use.

### SUMMARY

This application provides an electrochemical device. The electrochemical device includes a positive electrode plate and an electrolyte. The electrolyte includes a compound represented by Formula I:

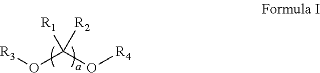

where a is an integer from 1 to 5, R₁ and R₂ are each independently selected from hydrogen, fluorine, C₁-C₃ alkyl substituted with fluorine, or unsubstituted C₁-C₃ alkyl, R₃ and R₄ are each independently selected from hydrogen, fluorine, C₁-C₆ alkyl substituted with fluorine, or unsubstituted C₁-C₆ alkyl, the compound represented by Formula I contains at least 4 fluorine atoms, a mass percentage of the compound represented by Formula I in the electrolyte is A %, and 7≤A≤72. The positive electrode plate includes a positive current collector, a first material layer and a second material layer, the second material layer is provided on at least one surface of the positive current collector, the first material layer is disposed between the positive current collector and the second material layer, a coating mass of the first material layer is x mg over an area of 1540.25 mm², a coating mass of the second material layer is y mg over an area of 1540.25 mm², and 15.4≤y/x≤2530.

In some embodiments, 25≤y/x≤980.

In some embodiments, the compound represented by Formula I includes at least one of compounds shown below:

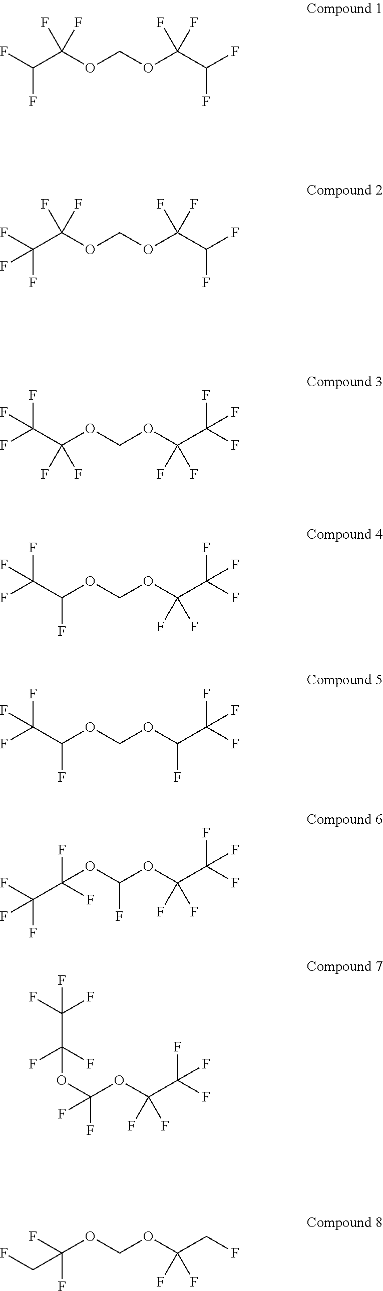

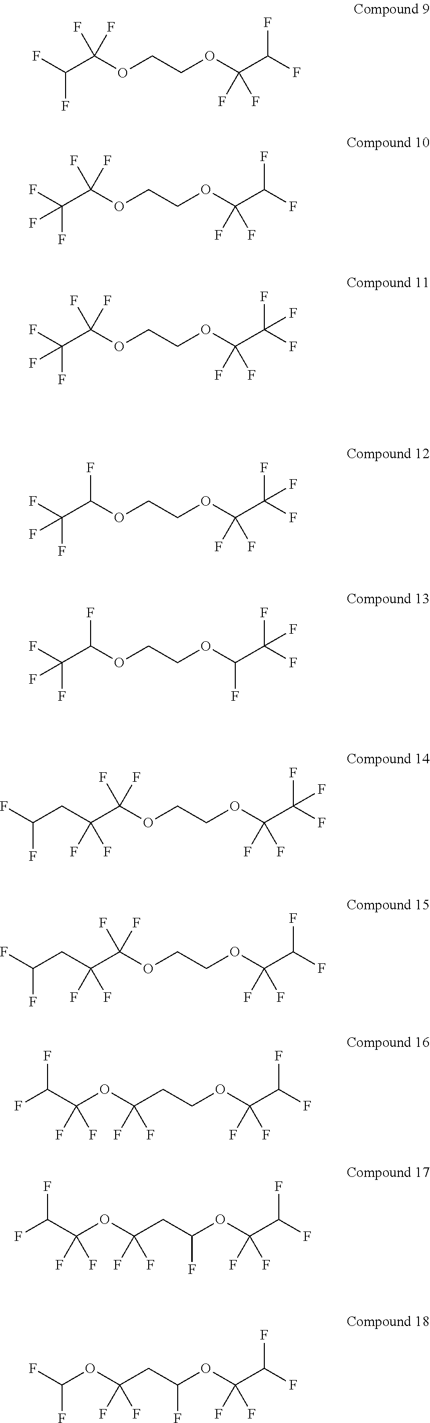

In some embodiments, 0.1≤x≤21. In some embodiments, 2≤x≤13. In some embodiments, 223≤y≤456. In some embodiments, 258≤y≤358. If x is too small, the improvement of positive and negative electrode short circuits is relatively limited and it may result in too large y/x. If x is too large, it affects the energy density of the electrochemical device and the electrical conductivity of the positive electrode plate. If y is too small, the energy density of the electrochemical device is affected and it may result in too small y/x. If y is too large, a transmission path of lithium ions in the positive electrode plate becomes longer, affecting the rate performance of the electrochemical device. Therefore, the suitable coating masses of the first material layer and the second material layer over a specific area can ensure good insulation effect and drop resistance effect of the electrochemical device.

In some embodiments, the first material layer includes a first inorganic metal oxide, and the first inorganic metal oxide includes at least one of calcium carbonate, boehmite, aluminum oxide, magnesium oxide, zirconium oxide, zinc oxide, titanium dioxide, tin dioxide or antimony trioxide. These first inorganic metal oxides have better insulation performance, which are conducive to enhancing the insulation effect of the first material layer and suppressing the positive and negative electrode short circuits. In some embodiments, the second material layer includes a second active material, and the second active material includes at least one of lithium cobalt oxide, nickel-cobalt-manganese ternary material, lithium iron phosphate or lithium manganate.

In some embodiments, the electrolyte further includes an additive, and the additive includes at least one of lithium difluoro(oxalato) borate, difluoropyridine, fluoroethylene carbonate, vinylene carbonate, lithium tetrafluoroborate, lithium difluorophosphate, succinonitrile, adipic dinitrile, or 1,3,6-hexanetricarbonitrile. By adding the additive, a number of the electrochemical device passing drop test can be further increased, as the addition of the additive will enhance the stability of an electrode interface, suppress the increase in internal temperature of the electrochemical device, and enhance the safety performance of the electrochemical device. In some embodiments, based on the total mass of the electrolyte, a mass percentage of the additive in the electrolyte is 0.1% to 10%. When a dosage of the above additive is too low, a film cannot be effectively formed. When the dosage is too high, the electrode interface is sufficiently stabilized, so that a higher content of additive cannot continue to enhance the drop performance, and the high content of additive will lead to an increase in the cost of the electrochemical device.

An embodiment of this application further provides an electronic device. The electronic device includes the electrochemical device described above.

According to this application, by adopting 7% to 72% of the compound represented by Formula I, the drop performance of the electrochemical device can be significantly enhanced, and the compound represented by Formula I has noninflammability, which can enhance the flame retardant effect of the electrolyte, suppress the increase of the internal temperature of the electrochemical device, and reduce the safety risk. In addition, when the electrochemical device is subjected to an impact, the second material layer will have a risk of detachment, causing the positive and negative electrode short circuits of the electrochemical device, triggering a series of chemical reactions and leading to the failure of the electrochemical device. The positive and negative electrode short circuits can be effectively relieved by forming the first material layer between the positive current collector and the second material layer. When a coating weight ratio y/x of the first material layer to the second material layer is too small, it may not only affect the energy density of the electrochemical device, but also affect the electrical conductivity of the positive electrode plate, deteriorate the cycling performance of the electrochemical device, also lead to detachment of the second material layer, and deteriorate the safety performance of the electrochemical device. When y/x is too large, the second material layer has a risk of being embedded in the positive current collector in the production process, thereby weakening the tensile strength of the positive current collector and leading to a reduction in the safety performance of the electrochemical device.

### DETAILED DESCRIPTION

The following embodiments will enable those skilled in the art to more fully understand this application, but do not limit this application in any way.

When an electrochemical device is subjected to an impact or needling, the second material layer will have a risk of detachment, causing positive and negative electrode short circuits of the electrochemical device and a subsequent temperature rise of the electrochemical device, triggering a series of chemical reactions and leading to the failure of the electrochemical device. When a first material layer (for example, a highly bonded and insulating first material layer) is provided between a positive current collector and a second material layer, positive and negative electrode short circuits can be effectively relieved. In addition, by controlling coating weights of the first material layer and the second material layer to be within a certain proportion range, it is effectively avoided that the second material layer is embedded in the positive current collector in the production process, thereby weakening the tensile strength of the positive current collector, at the same time, ensuring sufficient adhesion between the positive current collector and the first material layer as well as between the first material layer and the second material layer, and reducing detachment of the first material layer or the second material layer. In addition, the high flammability of an electrolyte will promote a sharp increase in temperature when the electrochemical device fails, and the introduction of a fluorine-substituted solvent into the electrolyte can effectively reduce the flammability of the electrolyte. Therefore, the probability of failure of the electrochemical device can be effectively reduced or the time of failure of the electrochemical device can be effectively delayed by the regulation of the positive electrode plate and the electrolyte.

This application provides an electrochemical device. The electrochemical device includes a positive electrode plate and an electrolyte. In some embodiments, the electrolyte includes a compound represented by Formula I:

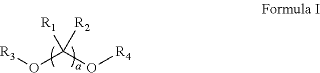

where a is an integer from 1 to 5, R₁ and R₂ are each independently selected from hydrogen, fluorine, C₁-C₃ alkyl substituted with fluorine, or unsubstituted C₁-C₃ alkyl, R₃ and R₄ are each independently selected from hydrogen, fluorine, C₁-C₆ alkyl substituted with fluorine, or unsubstituted C₁-C₆ alkyl, and the compound represented by Formula I contains at least 4 fluorine atoms. The compound represented by Formula I is used as a non-aqueous solvent in this application, and the compound represented by Formula I has noninflammability, which is conductive to suppressing the increase of an internal temperature of the electrochemical device, and reducing the safety risk.

In some embodiments, based on a total mass of the electrolyte, a mass percentage of the compound represented by Formula I is A %, 7≤A≤72. When a dosage of the compound represented by Formula I is too low, the flame retardant effect of the electrolyte cannot be enhanced. When the dosage is too high, the flame retardant property of the electrolyte cannot be further enhanced, and meanwhile, the kinetics of the electrolyte also deteriorates due to too high addition amount. Therefore, by controlling the content of the compound represented by Formula I to be within a range of 7% to 72%, better safety performance and electrical performance can be obtained.

In some embodiments, the positive electrode plate includes a positive current collector, a first material layer, and a second material layer, the second material layer is provided on at least one surface of the positive current collector, and the first material layer is disposed between the positive current collector and the second material layer. By providing the first material layer, it is conductive to relieving the positive and negative electrode short circuits. In some embodiments, a coating mass of the first material layer is x mg over an area of 1540.25 mm², a coating mass of the second material layer is y mg over an area of 1540.25 mm², and 15.4≤y/x≤2530. When a coating weight ratio y/x of the first material layer to the second material layer is too small, it may not only affect the energy density of the electrochemical device, but also affect the electrical conductivity of the positive electrode plate, deteriorate the cycling performance of the electrochemical device, also lead to falling off of the second material layer, and deteriorate the safety performance of the electrochemical device. When y/x is too large, the second material layer has a risk of being embedded in the positive current collector in the production process, thereby weakening the tensile strength of the positive current collector and leading to a reduction in the safety performance of the electrochemical device.

In some embodiments, 25≤y/x≤980. At the same time, the safety performance of the electrochemical device is better.

In some embodiments, the compound represented by Formula I includes at least one of compounds shown below, and the compounds have the better flame retardant property:

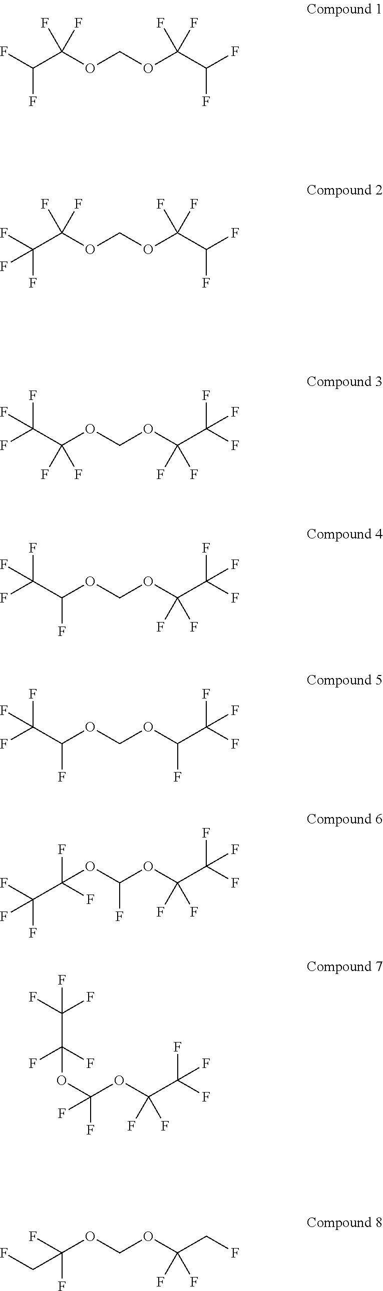

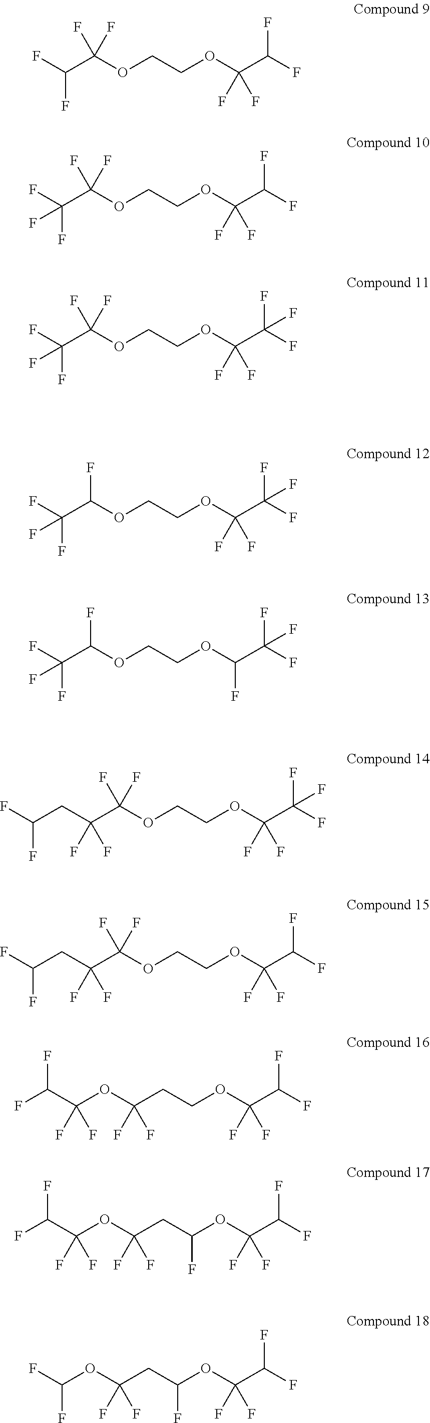

In some embodiments, 0.1≤x≤21. In some embodiments, 2≤x≤13. In some embodiments, 223≤y≤456. In some embodiments, 258≤y≤358. If x is too small, the improvement of positive and negative electrode short circuits is relatively limited and it may result in too large y/x. If x is too large, it affects the energy density of the electrochemical device and the electrical conductivity of the positive electrode plate. If y is too small, the energy density of the electrochemical device is affected and it may result in too small y/x. If y is too large, a transmission path of lithium ions in the positive electrode plate becomes longer, affecting the rate performance of the electrochemical device. Therefore, the suitable coating masses of the first material layer and the second material layer over a specific area can ensure good insulation effect and drop resistance effect of the electrochemical device.

In some embodiments, the first material layer includes a first inorganic metal oxide, and the first inorganic metal oxide includes at least one of calcium carbonate, boehmite, aluminum oxide, magnesium oxide, zirconium oxide, zinc oxide, titanium dioxide, tin dioxide or antimony trioxide. These first inorganic metal oxides have better insulation performance, which are conducive to enhancing the insulation effect of the first material layer and suppressing the positive and negative electrode short circuits. In some embodiments, the second material layer includes a second active material, and the second active material includes at least one of lithium cobalt oxide, nickel-cobalt-manganese ternary material, lithium iron phosphate or lithium manganate.

In some embodiments, the electrolyte further includes an additive, and the additive includes at least one of lithium difluoro(oxalato)borate, difluoropyridine, fluoroethylene carbonate, vinylene carbonate, lithium tetrafluoroborate, lithium difluorophosphate, succinonitrile, adipic dinitrile, or 1,3,6-hexanetricarbonitrile. By adding the additive, a number of the electrochemical device passing drop test can be further increased, as the addition of the additive will enhance the stability of an electrode interface, suppress the increase in internal temperature of the electrochemical device, and enhance the safety performance of the electrochemical device.

In some embodiments, based on the total mass of the electrolyte, a mass percentage of the above additive in the electrolyte is 0.1% to 10%. When a dosage of the above additive is too low, a film cannot be effectively formed. When the dosage is too high, the electrode interface is sufficiently stabilized, so that a higher content of additive cannot continue to enhance the drop performance, and the high content of additive will lead to an increase in the cost of the electrochemical device.

In some embodiments, the positive current collector may adopt aluminum foil. Certainly, other positive current collectors commonly used in the art may also be used. In some embodiments, a thickness of the positive current collector may be 1 μm to 50 μm. It should be understood that these are only exemplary and other suitable thicknesses may be adopted.

In some embodiments, the first material layer further a first binder and a first conductive agent. In some embodiments, the second material layer further includes a second binder and a second conductive agent. In some embodiments, the first binder and the second binder may independently include at least one of polyvinylidene fluoride, vinylidene fluoride-hexafluoropropylene copolymer, styrene-acrylate copolymer, Styrene-butadiene copolymers, polyamide, polyacrylonitrile, polyacrylate ester, polyacrylate, polyacrylate salt, sodium carboxymethyl cellulose, polyvinyl acetate, polyvinylpyrrolidone, polyvinyl ether, polymethyl methacrylate, polytetrafluoroethylene, or polyhexafluoropropylene. In some embodiments, the first conductive agent and the second conductive agent may independently include at least one of conductive carbon black, acetylene black, Ketjen black, lamellar graphite, graphene, carbon nanotubes, or carbon fibers. In some embodiments, a mass ratio of the first inorganic metal oxide to the first conductive agent to the first binder in the first material layer may be (70 to 98):(1 to 15):(1 to 15). In some embodiments, a mass ratio of the second active material to the second conductive agent to the second binder in the second material layer may be (70 to 98):(1 to 15):(1 to 15). It should be understood that the foregoing is merely exemplary and the first material layer and the second material layer may be of any other suitable material and mass ratio.

In some embodiments, the electrolyte may further include other non-aqueous organic solvents and electrolyte salts. The non-aqueous organic solvent may include at least one of carbonate, carboxylate, ether, or other non-protonic solvents. Examples of carbonate solvents include dimethyl carbonate, diethyl carbonate, methyl ethyl carbonate, methyl propyl carbonate, ethyl propyl carbonate, dipropyl carbonate, ethylene carbonate, propylene carbonate, 2,3-butylene carbonate, bis(2,2,2-trifluoroethyl) carbonate, and the like. Examples of carboxylate solvents include methyl acetate, ethyl acetate, n-propyl acetate, n-butyl acetate, methyl propionate, ethyl propionate, propyl propionate, butyl propionate, methyl butyrate, ethyl butyrate, propyl butyrate, butyl butyrate, γ-butyrolactone, 2,2-difluoroethyl acetate, valerolactone, butyrolactone, ethyl difluoroacetate, 2,2-difluoroethyl acetate, ethyl trifluoroacetate, 2,2,3,3,3-ethyl pentafluoropropionate, 2,2,3,3,4,4,4,4-methyl heptafluorobutyrate, methyl 4,4,4-trifluoro-3-(trifluoromethyl)butanoate, 2,2,3,3,4,4,5,5,5,5-ethyl nonafluorovalerate, 2,2,3,3,4,4,5,5,6,6,7,7,8,8,9,9,9-methyl heptadecafluorononanoic acid, 2,2,3,3,4,4,5,5,6,6,7,7,8,8,9,9,9,-ethyl heptadecafluorononanoic acid, and the like. Examples of ether solvents include dimethoxyethane, bis(2-methoxy ethyl)ether, tetraethylene glycol dimethyl ether, dibutyl ether, tetrahydrofuran, 2-methyltetrahydrofuran, bis(2,2,2-trifluoroethyl) ether, and the like.

In some embodiments, the electrolyte salt of this application includes at least one of an organic lithium salt or an inorganic lithium salt. In some embodiments, the electrolyte salt includes at least one of lithium hexafluorophosphate LiPF₆, lithium bis(trifluoromethanesulphonyl)imide LiN(CF₃SO₂)₂ (abbreviated LiTFSI), lithium bis(fluorosulfonyl)imide Li(N(SO₂F)₂) (abbreviated LiFSI), or lithium hexafluorocesanate (LiCsF₆), lithium perchlorate LiClO₄, or lithium trifluoromethanesulfonate LiCF₃SO₃.

In some embodiments, the electrochemical device may include an electrode assembly, and the electrode assembly includes a positive electrode plate, a negative electrode plate, a separator disposed between the positive electrode plate and the negative electrode plate and an electrolyte. In some embodiments, the electrolyte is the electrolyte described above, and the positive electrode plate is the positive electrode plate described above.

In some embodiments, the negative electrode plate may include a negative current collector and a negative active material layer disposed on the negative current collector. The negative active material layer may be disposed on one side or two sides of the negative current collector. In some embodiments, the negative current collector may adopt at least one of copper foil, aluminum foil, nickel foil or a carbon-based current collector. In some embodiments, the negative current collector may have a thickness ranging from 1 μm to 200 μm. In some embodiments, the negative active material layer may only be coated on a partial region of the negative current collector. In some embodiments, the negative active material layer may have a thickness ranging from 10 μm to 500 μm. It should be understood that these are only exemplary and other suitable thicknesses may be adopted.

In some embodiments, the negative active material layer includes a negative active material, as described above. In some embodiments, the negative active material in the negative active material layer includes at least one of lithium metal, natural graphite, artificial graphite, or a silicon-based material. In some embodiments, the silicon-based material includes at least one of silicon, a silicon oxygen compound, a silicon carbon compound, or a silicon alloy.

In some embodiments, the negative active material layer may further include a conductive agent and/or a binder. The conductive agent in the negative active material layer may include at least one of carbon black, acetylene black, Ketjen black, lamellar graphite, graphene, carbon nanotubes, carbon fibers, or carbon nanowires. In some embodiments, the binder in the negative active material layer may include at least one of carboxymethylcellulose (CMC), polyacrylate, polyacrylate salt, polyacrylate ester, polyvinyl pyrrolidone, polyaniline, polyimide, polyamideimide, polysiloxane, styrene-butadiene rubber, epoxy resin, polyester resin, polyurethane resin, or polyfluorene. It should be understood that the materials disclosed above are merely exemplary and the negative active material layer may be of any other suitable material. In some embodiments, a mass ratio of the negative active material to the conductive agent to the binder in the negative active material layer may be (80 to 99):(0.5 to 10): (0.5 to 10). It should be understood that the foregoing is merely exemplary, and is not used to limit this application.

In some embodiments, the separator includes at least one of polyethylene, polypropylene, polyvinylidene fluoride, polyethylene terephthalate, polyimide or aramid. For example, the polyethylene includes and is selected from at least one of high density polyethylene, low density polyethylene or ultra-high molecular weight polyethylene. Polyethylene and polypropylene, in particular, have a good effect on preventing short circuits and can improve stability of a battery through a turn-off effect. In some embodiments, a thickness of the separator falls within a range of about 3 μm to 500 μm.

In some embodiments, a surface of the separator may further include a porous layer, and the porous layer is disposed on at least one surface of the separator. The porous layer includes at least one of an inorganic particle or a binder. The inorganic particle is selected from at least one of aluminum oxide (Al₂O₃), silicon oxide (SiO₂), magnesium oxide (MgO), titanium oxide (TiO₂), hafnium oxide (HfO₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminium hydroxide, magnesium hydroxide, calcium hydroxide or barium sulfate. In some embodiments, pores of the separator have a diameter ranging from about 0.01 μm to 1 μm. The binder of the porous layer is selected from at least one of polyvinylidene fluoride, a vinylidene fluoride-hexafluoropropylene copolymer, polyamide, polyacrylonitrile, polyacrylate ester, polyacrylate, polyacrylate salt, sodium carboxymethyl cellulose, polyvinylpyrrolidone, polyvinyl ether, polymethyl methacrylate, polytetrafluoroethylene or polyhexafluoropropylene. The porous layer on the surface of the separator can enhance heat resistance, oxidation resistance and electrolyte wettability of the separator and enhance bonding performance between the separator and an electrode plate.

In some embodiments of this application, the electrode assembly of the electrochemical device is a coiled electrode assembly, or a stacked electrode assembly. In some embodiments, the electrochemical device is a lithium-ion battery, but this application is not limited thereto.

In some embodiments of this application, taking a lithium-ion battery as an example, a positive electrode plate, a separator and a negative electrode plate are sequentially wound or stacked into an electrode assembly, then the electrode assembly is put into, for example, an aluminum-plastic film housing for packaging, an electrolyte is injected, chemical formation and packaging are performed, and then the lithium-ion battery is prepared. Then a performance test is performed on the prepared lithium-ion battery.

A person skilled in the art will understand that the preparation method of the electrochemical device (e.g. lithium-ion battery) described above are merely an embodiment. Other methods frequently used in the art may be adopted without departing from the disclosure of this application.

An embodiment of this application further provides an electronic device including the foregoing electrochemical device. The electronic device according to the embodiment of this application is not particularly limited, and may be any known electronic device used in the prior art. In some embodiments, the electronic device may include, but is not limited to, a notebook computer, a pen-inputting computer, a mobile computer, an e-book player, a portable phone, a portable fax machine, a portable photocopier, a portable printer, a stereo headset, a video recorder, a liquid crystal display television, a handheld cleaner, a portable CD player, a mini disk, a transceiver, an electronic notepad, a calculator, a memory card, a portable voice recorder, a radio, a backup power supply, a motor, an automobile, a motorcycle, a power-assisted bicycle, a bicycle, a lighting appliance, a toy, a game console, a watch, an electric tool, a flashlight, a camera, a large household battery, a lithium-ion capacitor, and the like.

Some specific embodiments and comparative embodiments are listed below to better illustrate this application, wherein the lithium-ion battery is used as an example.

### Embodiment 1-1

Preparing a positive electrode plate: mixing calcium carbonate as a first inorganic metal oxide, polyvinylidene difluoride (PVDF) as a first binder, and conductive carbon black as a first conductive agent according to a mass ratio of 80:10:10, and adding N-methyl-pyrrolidone (NMP) as a solvent to prepare a slurry with a solid content of 30%, then stirring the slurry evenly. Evenly coating the slurry on 12-μm thick positive current collector aluminum foil, and drying the positive current collector aluminum foil at 90° C., to obtain a first material layer.

Using lithium cobalt oxide as a second active material, polyvinylidene difluoride (PVDF) as a second binder and conductive carbon black (Super-P) as a second conductive agent, dissolving them into N-methyl-pyrrolidone (NMP) at a mass ratio of 96:2:2, and evenly mixing them to prepare a positive electrode slurry. Evenly coating the positive electrode slurry on the first material layer and baking the first material layer for 1 h at 120° C., and performing compaction and slitting to obtain a positive electrode plate.

Preparing a negative electrode plate: using artificial graphite as a negative active material, conductive carbon black as a conductive agent, styrene-butadiene rubber (SBR) as a binder and sodium carboxymethyl cellulose (CMC) as a thickening agent, dissolving them in deionized water according to a weight ratio of 85:3:10:2 to form a negative electrode slurry. Using 12-μm thick copper foil as a negative current collector, coating the negative electrode slurry on the negative current collector, performing drying at 85° C., cold compaction and cutting to obtain a negative electrode plate. A thickness of a negative active material layer is 110 μm.

Preparing a separator: using polyethylene (PE) of 8 μm in thickness as a separator.

Preparing an electrolyte: adding 3M of lithium bis(fluorosulfonyl)imide (LiFSI) into a diethyl carbonate solution to be as a base electrolyte, and adding a compound represented by Formula I after complete dissolution.

Preparing a lithium-ion battery: stacking the positive electrode plate, the separator, and the negative electrode plate are in sequence, so the separator is disposed between the positive electrode plate and the negative electrode plate to play a role of separation, and wounding the stacked structure to obtain an electrode assembly. Putting the electrode assembly into an outer aluminum-plastic film package, removing water at 80° C., injecting the foregoing electrolyte, sealing the package, and to obtain the lithium-ion battery (3.3 mm thick, 39 mm wide and 96 mm long) through chemical formation (80° C., charged to 3.5 V at a constant current of 0.02 C, and then charged to 3.9 V at a constant current of 0.1 C), degassing, edge trimming and other processes.

The test methods for the parameters of this application are described below.

Coating weight: measuring coating weights of a first material layer and a second material layer on a current collector by differential subtraction; and firstly weighing positive current collectors not coated with any material in an area of 1540.25 mm², and the number of the weighed positive current collectors being 10, and taking an average value as a base positive current collector weight t. After coating the first material layer on one side of the positive current collector, weighing the positive current collectors of an area of 1540.25 mm², the number of weighed positive current collectors being 10, and taking an average value as a weight T. Coating the second material layer on the first material layer, weighing the current collectors of an area of 1540.25 mm², the number of weighed current collectors being 10, and taking an average value as a weight N. Then, the coating weight of the first material layer=T−t; and the coating weight of the second material layer=N−T.

Drop test: lithium-ion batteries with high-temperature cycle of 200 cycles are, under the condition of 25° C., charged to 4.45 V at a constant current of 0.5 C, and charged to a current of 0.025 C at CV (constant-voltage, constant-voltage charging). In the test environment of 20±5° C., on a concrete drop floor and from a 2 m drop height, dropping along 3 sides of the lithium-ion batteries once, dropping along 3 edges of the lithium-ion batteries once, and dropping along 8 corners of the lithium-ion batteries once, a total of 1 round of testing is performed, and the order of dropping is (3 sides of 1 time each→3 edges of 1 time each→8 corners of 1 time each). And the to-be-tested lithium-ion batteries do not smoke, leak liquid, catch fire, or explode, which is considered to pass the test. 50 lithium-ion batteries are tested in each group.

Table 1 illustrates parameters and assessment results for Embodiments 1-1 to 1-26 and Comparative Embodiments 1-1 to 1-4. Except for the differences shown in Table 1, the parameters of Embodiments 1-2 to 1-26 and Comparative Embodiments 1-1 to 1-4 are the same as those of Embodiment 1-1.

TABLE 1

| | | | | | | Number |
|---|---|---|---|---|---|---|
| | | | Coating | | | of |
| | | | weight | | | lithium- |
| | | | x(mg) of | Coating | | ion |
| | Compound | | first | weight y(mg) | | batteries |
| | represented by | | material | of second | | passing |
| | Formula I | A(%) | layer | material layer | y/x | drop test |
| Comparative | / | 6 | 25 | 375 | 15 | 5 |
| Embodiment | | | | | | |
| 1-1 | | | | | | |
| Comparative | / | 6 | 25 | 385 | 15.4 | 8 |
| Embodiment | | | | | | |
| 1-2 | | | | | | |
| Comparative | Compound 1 | 7 | 25 | 375 | 15 | 9 |
| Embodiment | | | | | | |
| 1-3 | | | | | | |
| Embodiment | Compound 1 | 7 | 25 | 385 | 15.4 | 15 |
| 1-1 | | | | | | |
| Embodiment | Compound 1 | 15 | 25 | 385 | 15.4 | 16 |
| 1-2 | | | | | | |
| Embodiment | Compound 1 | 25 | 25 | 385 | 15.4 | 17 |
| 1-3 | | | | | | |
| Embodiment | Compound 1 | 35 | 25 | 385 | 15.4 | 20 |
| 1-4 | | | | | | |
| Embodiment | Compound 1 | 50 | 25 | 385 | 15.4 | 23 |
| 1-5 | | | | | | |
| Embodiment | Compound 1 | 60 | 25 | 385 | 15.4 | 25 |
| 1-6 | | | | | | |
| Embodiment | Compound 1 | 70 | 25 | 385 | 15.4 | 26 |
| 1-7 | | | | | | |
| Embodiment | Compound 1 | 72 | 25 | 385 | 15.4 | 27 |
| 1-8 | | | | | | |
| Embodiment | Compound 1 | 75 | 25 | 385 | 15.4 | 27 |
| 1-9 | | | | | | |
| Embodiment | Compound 1 | 50 | 20 | 385 | 19.2 | 28 |
| 1-10 | | | | | | |
| Embodiment | Compound 1 | 50 | 15.4 | 385 | 25 | 30 |
| 1-11 | | | | | | |
| Embodiment | Compound 1 | 50 | 5 | 385 | 77 | 30 |
| 1-12 | | | | | | |
| Embodiment | Compound 1 | 50 | 1 | 385 | 385 | 30 |
| 1-13 | | | | | | |
| Embodiment | Compound 1 | 50 | 0.4 | 385 | 980 | 30 |
| 1-14 | | | | | | |
| Embodiment | Compound 1 | 50 | 0.2 | 385 | 1985 | 28 |
| 1-15 | | | | | | |
| Embodiment | Compound 1 | 50 | 0.15 | 385 | 2530 | 28 |
| 1-16 | | | | | | |
| Comparative | Compound 1 | 50 | 0.14 | 385 | 2750 | 10 |
| Embodiment | | | | | | |
| 1-4 | | | | | | |
| Embodiment | Compound 2 | 50 | 1 | 385 | 385 | 29 |
| 1-17 | | | | | | |
| Embodiment | Compound 4 | 50 | 1 | 385 | 385 | 30 |
| 1-18 | | | | | | |
| Embodiment | Compound 5 | 50 | 1 | 385 | 385 | 31 |
| 1-19 | | | | | | |
| Embodiment | Compound 8 | 50 | 1 | 385 | 385 | 31 |
| 1-20 | | | | | | |
| Embodiment | Compound 10 | 50 | 1 | 385 | 385 | 28 |
| 1-21 | | | | | | |
| Embodiment | Compound 16 | 50 | 1 | 385 | 385 | 29 |
| 1-22 | | | | | | |
| Embodiment | Compound 1 + | 50 | 1 | 385 | 385 | 32 |
| 1-23 | Compound 3 | | | | | |
| Embodiment | Compound 1 + | 50 | 1 | 385 | 385 | 34 |
| 1-24 | Compound 3 | | | | | |
| Embodiment | Compound 1 + | 50 | 1 | 385 | 385 | 31 |
| 1-25 | Compound 3 | | | | | |
| Embodiment | Compound 1 + | 50 | 1 | 385 | 385 | 30 |
| 1-26 | Compound 3 + | | | | | |
| | Compound 10 | | | | | |

As can be seen from Table 1, the drop performance is poor in Comparative embodiments 1-1 to 1-4 due to insufficient addition of the compound represented by Formula I or y/x not being within a suitable range, and in Embodiments 1-1 to 1-26, the drop performance of the lithium-ion batteries can be significantly enhanced by the addition of the compound represented by Formula I. The compound represented by Formula I has noninflammability. When the addition amount is too low, the flame retardant effect of the electrolyte cannot be enhanced. When the addition amount is too high, the flame retardant property of the electrolyte cannot be further enhanced, and meanwhile, the kinetics of the electrolyte also deteriorates due to too high addition amount. Therefore, by controlling the content of the compound represented by Formula I to be within a range of 7% to 72%, better safety performance and electrical performance can be obtained.

In addition, a value of y/x also affects the safety performance of the battery. When the lithium-ion battery is subjected to an impact, the second material layer will have a risk of detachment, causing the positive and negative electrode short circuits of the lithium-ion battery, triggering a series of chemical reactions and leading to the failure of the lithium-ion battery. The positive and negative electrode short circuits can be effectively relieved by providing the highly bonded and insulating first material layer on the positive electrode plate. When a coating weight ratio y/x of the first material layer to the second material layer is too small, it may not only affect the energy density of the lithium-ion battery, but also affect the electrical conductivity of the positive electrode plate, deteriorate the cycling performance of the lithium-ion battery, also lead to detachment of the second material layer, and deteriorate the safety performance of the lithium-ion battery. When y/x is too large, the second material layer has a risk of being embedded in the positive current collector in the production process, thereby weakening the tensile strength of the positive current collector and leading to a reduction in the safety performance of the lithium-ion battery.

In addition, as can be seen by Embodiments 1-17 to 1-26, the effect of enhancing the drop performance of the lithium-ion batteries can also be obtained by employing one or a combination of more of the compounds represented by Formula I.

Table 2 illustrates parameters and assessment results for Embodiments 1-3, and 2-1 to 2-23. Except for the differences shown in Table 2, the parameters of Embodiments 2-1 to 2-23 are the same as those of Embodiment 1-3.

TABLE 2

| | | | | | | Number |
|---|---|---|---|---|---|---|
| | | | Coating | | | of |
| | | Active | weight | | | lithium- |
| | Active | material of | x(mg) of | Coating | | ion |
| | material of | second | first | weight y(mg) | | batteries |
| | first material | material | material | of second | | passing |
| | layer | layer | layer | material layer | y/x | drop test |
| Embodiment | Calcium | Lithium | 25 | 385 | 15.4 | 17 |
| 1-3 | carbonate | cobalt oxide | | | | |
| Embodiment | Calcium | Lithium | 21 | 385 | 18.3 | 28 |
| 2-1 | carbonate | cobalt oxide | | | | |
| Embodiment | Calcium | Lithium | 18 | 385 | 21.3 | 29 |
| 2-2 | carbonate | cobalt oxide | | | | |
| Embodiment | Calcium | Lithium | 13 | 385 | 29.6 | 30 |
| 2-3 | carbonate | cobalt oxide | | | | |
| Embodiment | Calcium | Lithium | 9 | 385 | 42.7 | 30 |
| 2-4 | carbonate | cobalt oxide | | | | |
| Embodiment | Calcium | Lithium | 5 | 385 | 77 | 30 |
| 2-5 | carbonate | cobalt oxide | | | | |
| Embodiment | Calcium | Lithium | 2 | 385 | 192.5 | 30 |
| 2-6 | carbonate | cobalt oxide | | | | |
| Embodiment | Calcium | Lithium | 0.5 | 385 | 770 | 29 |
| 2-7 | carbonate | cobalt oxide | | | | |
| Embodiment | Calcium | Lithium | 0.1 | 200 | 2000 | 28 |
| 2-8 | carbonate | cobalt oxide | | | | |
| Embodiment | Calcium | Lithium | 0.09 | 200 | 2222 | 25 |
| 2-9 | carbonate | cobalt oxide | | | | |
| Embodiment | Calcium | Lithium | 2 | 370 | 185 | 30 |
| 2-10 | carbonate | cobalt oxide | | | | |
| Embodiments | Calcium | Lithium | 2 | 358 | 179 | 31 |
| 2-11 | carbonate | cobalt oxide | | | | |
| Embodiment | Calcium | Lithium | 2 | 320 | 160 | 32 |
| 2-12 | carbonate | cobalt oxide | | | | |
| Embodiment | Calcium | Lithium | 2 | 300 | 150 | 33 |
| 2-13 | carbonate | cobalt oxide | | | | |
| Embodiment | Calcium | Lithium | 2 | 287 | 143.5 | 33 |
| 2-14 | carbonate | cobalt oxide | | | | |
| Embodiment | Calcium | Lithium | 2 | 258 | 129 | 35 |
| 2-15 | carbonate | cobalt oxide | | | | |
| Embodiment | Calcium | Lithium | 2 | 245 | 72.5 | 31 |
| 2-16 | carbonate | cobalt oxide | | | | |
| Embodiment | Calcium | Lithium | 2 | 223 | 111.5 | 30 |
| 2-17 | carbonate | cobalt oxide | | | | |
| Embodiment | Calcium | Lithium | 2 | 400 | 200 | 29 |
| 2-18 | carbonate | cobalt oxide | | | | |
| Embodiment | Calcium | Lithium | 2 | 432 | 216 | 29 |
| 2-19 | carbonate | cobalt oxide | | | | |
| Embodiment | Calcium | Lithium | 2 | 456 | 228 | 29 |
| 2-20 | carbonate | cobalt oxide | | | | |
| Embodiment | Calcium | Lithium | 2 | 460 | 230 | 26 |
| 2-21 | carbonate | cobalt oxide | | | | |
| Embodiment | Calcium | Lithium | 2 | 300 | 150 | 33 |
| 2-21 | carbonate + | cobalt oxide | | | | |
| | Aluminum | | | | | |
| | oxide | | | | | |
| Embodiment | Titanium | Lithium iron | 2 | 300 | 150 | 34 |
| 2-22 | dioxide + | phosphate | | | | |
| | magnesium | | | | | |
| | oxide | | | | | |
| Embodiment | Zirconium | Lithium | 2 | 300 | 150 | 32 |
| 2-23 | oxide + | manganate + | | | | |
| | titanium | lithium iron | | | | |
| | dioxide | phosphate | | | | |

As can be seen from Table 2, the drop performance can be enhanced by adjusting the coating weights of the first material layer and the second material layer, where x ranges from 0.1 to 21, preferably from 2 to 13, and y ranges from 223 to 456, preferably from 258 to 358, and the suitable thicknesses of the first material layer and the second material layer can ensure the insulation effect and the drop resistance effect.

Table 3 illustrates parameters and assessment results for Embodiments 2-6 and 3-1 to 3-10. Except for the differences shown in Table 3, the parameters of Embodiments 3-1 to 3-10 are the same as those of Embodiment 2-6.

TABLE 3

| | | | Number of |
|---|---|---|---|
| | | | lithium-ion |
| | | Content B(%) of | batteries passing |
| | Additive | additive | drop test |
| Embodiment | / | 0 | 30 |
| 2-6 | | | |
| Embodiment | Succinonitrile | 0.05 | 30 |
| 3-1 | | | |
| Embodiment | Succinonitrile | 0.1 | 31 |
| 3-2 | | | |
| Embodiment | Succinonitrile | 1 | 35 |
| 3-3 | | | |
| Embodiment | Succinonitrile | 3 | 37 |
| 3-4 | | | |
| Embodiment | Succinonitrile | 5 | 40 |
| 3-5 | | | |
| Embodiment | Succinonitrile | 10 | 44 |
| 3-6 | | | |
| Embodiment | Succinonitrile | 11 | 44 |
| 3-7 | | | |
| Embodiment | Succinonitrile + lithium | 1 + 0.5 | 38 |
| 3-8 | difluoro(oxalato) borate | | |
| Embodiment | Vinylene carbonate + 1,3,6- | 0.5 + 2 | 36 |
| 3-9 | hexanetricarbonitrile | | |
| Embodiment | Lithium tetrafluoroborate + | 0.3 + 0.1 + 0.5 | 37 |
| 3-10 | difluoropyridine + lithium | | |
| | difluorophosphate | | |

It can be seen from Table 3 that by adding the additive, the number of lithium-ion batteries passing drop test can be further enhanced, as the addition of the additive will enhance the stability of an electrode interface, suppress the increase in internal temperature of the lithium-ion batteries, and enhance the safety performance of the lithium-ion batteries. When the mass content of the additive is from 0.1% to 10%, the comprehensive performance of the lithium-ion batteries is better. When an addition amount of the above additive is too low, a film cannot be effectively formed. When the addition amount is too high, the electrode interface is sufficiently stabilized, so that a higher content of additive cannot continue to enhance the drop performance of the lithium-ion batteries, and the high content of additive will lead to an increase in the cost of the lithium-ion batteries. In addition, it can be seen from Embodiments 3-8 to 3-10 that different types of additives can be independently used or used in a combined manner, both of which can achieve the purpose of improving the drop performance of the lithium-ion batteries.

What is described above is merely preferred embodiments of this application and an illustration of technical principles utilized. A person skilled in the art understands that the scope of the disclosure involved in this application is not limited to the technical solutions formed by particular combinations of the foregoing technical features, but also covers other technical solutions formed by any combinations of the foregoing technical features or equivalent features thereof, for example, the technical solutions formed by mutual replacement of the foregoing features and the technical features having similar functions disclosed in this application.

What is claimed is:

1. An electrochemical device, comprising:
a positive electrode plate and an electrolyte; and the electrolyte comprises a compound represented by Formula I: 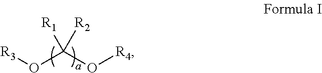
wherein a is an integer from 1 to 5; R₁ and R₂ are each independently selected from hydrogen, fluorine, C₁-C₃ alkyl substituted with fluorine, or unsubstituted C₁-C₃ alkyl; R₃ and R₄ are each independently selected from hydrogen, fluorine, C₁-C₆ alkyl substituted with fluorine, or unsubstituted C₁-C₆ alkyl; the compound represented by Formula I contains at least 4 fluorine atoms; based on a total mass of the electrolyte, a mass percentage of the compound represented by Formula I is A %, and 7≤A≤72; and
wherein the positive electrode plate comprises a positive current collector, a first material layer and a second material layer; the second material layer is provided on at least one surface of the positive current collector, the first material layer is disposed between the positive current collector and the second material layer; a coating mass of the first material layer is x mg over an area of 1540.25 mm², a coating mass of the second material layer is y mg over an area of 1540.25 mm², and 15.4≤y/x≤2530.

2. The electrochemical device according to claim 1, wherein 25≤y/x≤980.

3. The electrochemical device according to claim 1, wherein the compound represented by Formula I comprises at least one of the following compounds:

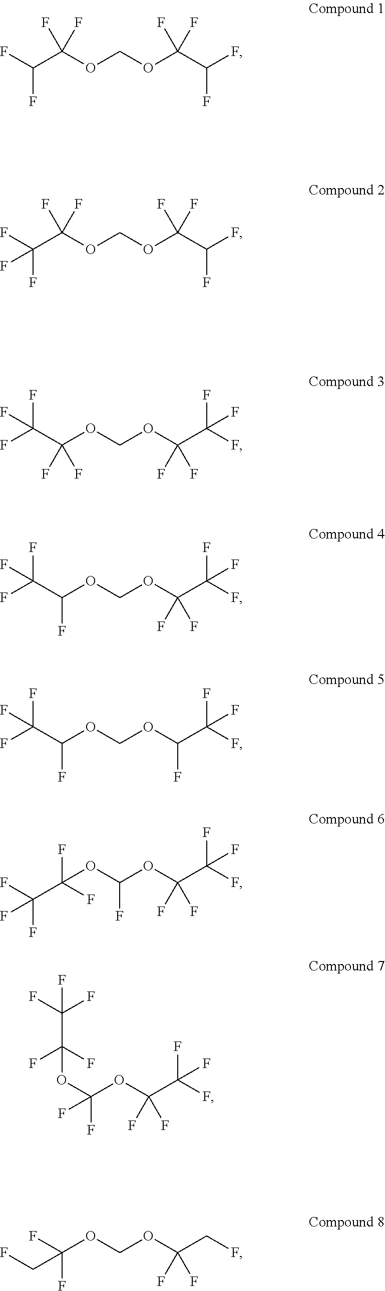

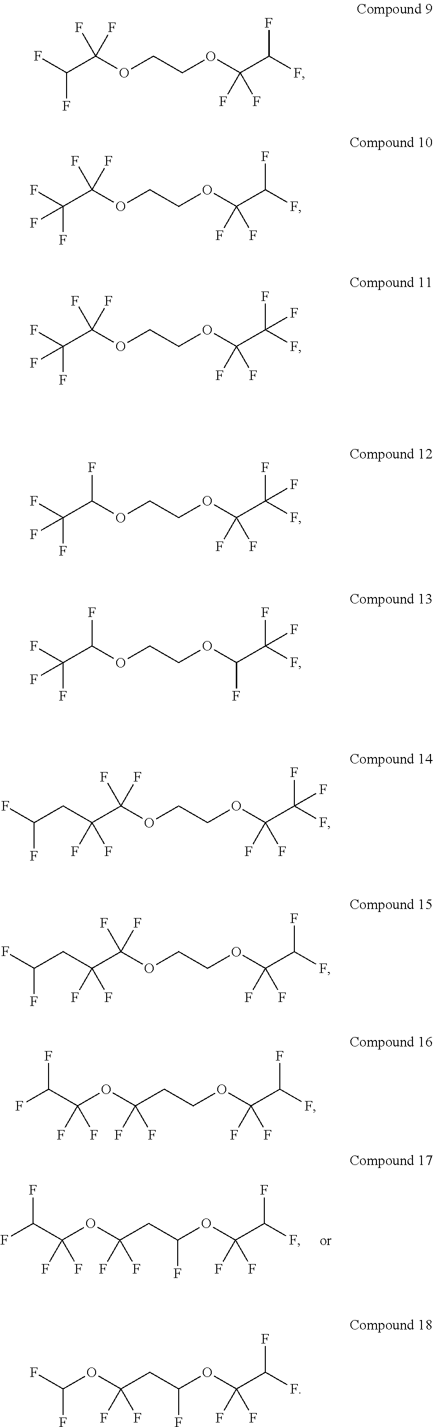

4. The electrochemical device according to claim 1, wherein at least one of the following conditions is satisfied:
1) 0.1≤x≤21; or
2) 223≤y≤456.

5. The electrochemical device according to claim 1, wherein at least one of the following conditions is satisfied:
1) 2≤x≤13; or
2) 258≤y≤358.

6. The electrochemical device according to claim 1, wherein the first material layer comprises a first inorganic metal oxide; and the first inorganic metal oxide comprises at least one of calcium carbonate, boehmite, aluminum oxide, magnesium oxide, zirconium oxide, zinc oxide, titanium dioxide, tin dioxide or antimony trioxide.

7. The electrochemical device according to claim 1, wherein the second material layer comprises a second active material; and the second active material comprises at least one of lithium cobalt oxide, nickel-cobalt-manganese ternary material, lithium iron phosphate or lithium manganate.

8. The electrochemical device according to claim 1, wherein the electrolyte further comprises an additive; and the additive comprises at least one of lithium difluoro(oxalato) borate, difluoropyridine, fluoroethylene carbonate, vinylene carbonate, lithium tetrafluoroborate, lithium difluorophosphate, succinonitrile, adipic dinitrile, or 1,3,6-hexanetricarbonitrile.

9. The electrochemical device according to claim 8, wherein based on the total mass of the electrolyte, a mass percentage of the additive is 0.1% to 10%.

10. An electronic device, comprising an electrochemical device; the electrochemical device comprises a positive electrode plate and an electrolyte; and the electrolyte comprises a compound represented by Formula I: 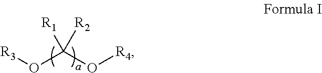
wherein a is an integer from 1 to 5; R1 and R2 are each independently selected from hydrogen, fluorine, C1-C3 alkyl substituted with fluorine, or unsubstituted C1-C3 alkyl; R3 and R4 are each independently selected from hydrogen, fluorine, C1-C6 alkyl substituted with fluorine, or unsubstituted C1-C6 alkyl; the compound represented by Formula I contains at least 4 fluorine atoms; based on a total mass of the electrolyte, a mass percentage of the compound represented by Formula I is A %, and 7≤A≤72; and
wherein the positive electrode plate comprises a positive current collector, a first material layer and a second material layer; the second material layer is provided on at least one surface of the positive current collector, the first material layer is disposed between the positive current collector and the second material layer; a coating mass of the first material layer is x mg over an area of 1540.25 mm2, a coating mass of the second material layer is y mg over an area of 1540.25 mm2, and 15.4≤y/x≤2530.

11. The electronic device according to claim 10, wherein 25≤y/x≤980.

12. The electronic device according to claim 10, wherein the compound represented by Formula I comprises at least one of compounds shown below:

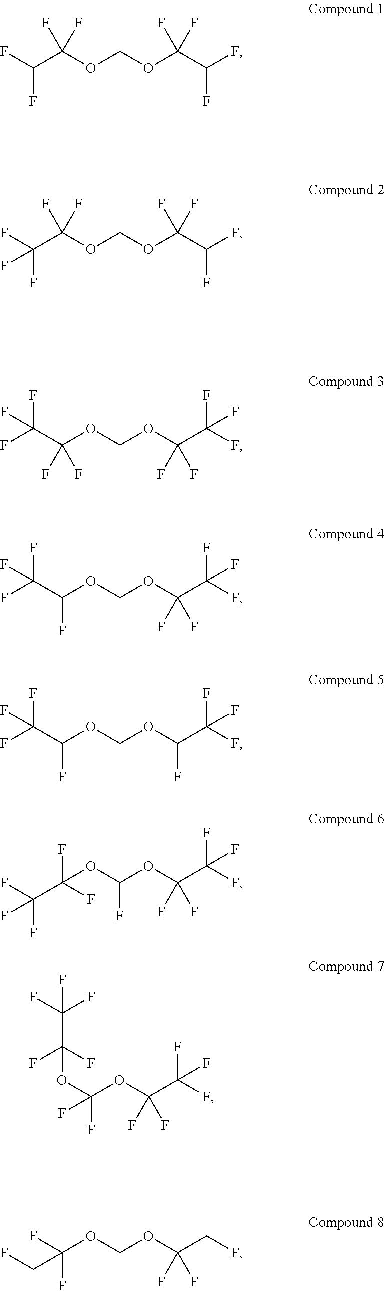

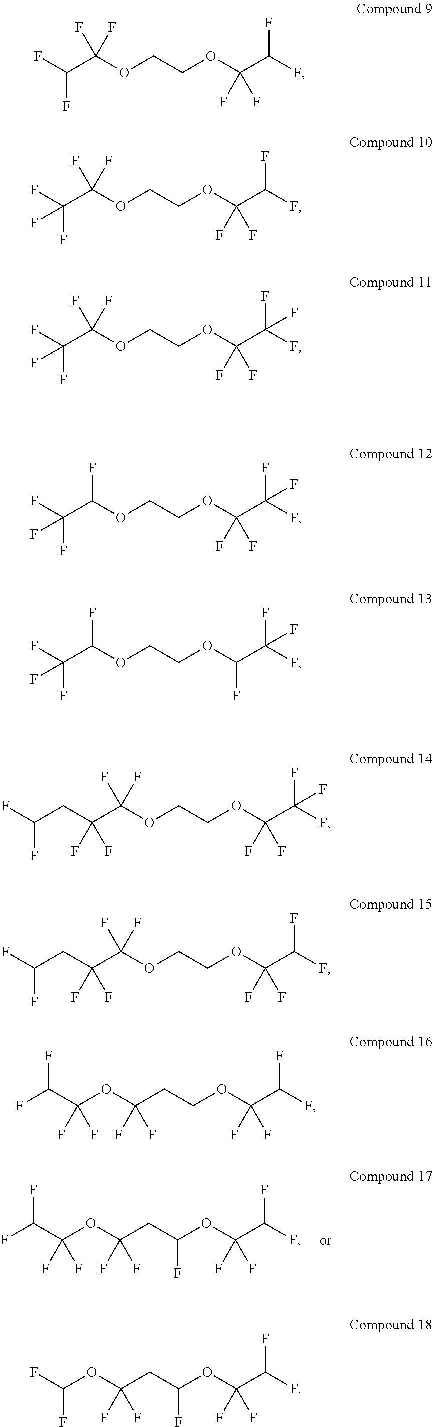

13. The electronic device according to claim 10, wherein at least one of the following conditions is satisfied:
1) 0.1≤x≤21; or
2) 223≤y≤456.

14. The electronic device according to claim 10, wherein at least one of the following conditions is satisfied:
1) 2≤x≤13; or
2) 258≤y≤358.

15. The electronic device according to claim 10, wherein the first material layer comprises a first inorganic metal oxide, and the first inorganic metal oxide comprises at least one of calcium carbonate, boehmite, aluminum oxide, magnesium oxide, zirconium oxide, zinc oxide, titanium dioxide, tin dioxide or antimony trioxide.

16. The electronic device according to claim 10, wherein the second material layer comprises a second active material; and the second active material comprises at least one of lithium cobalt oxide, nickel-cobalt-manganese ternary material, lithium iron phosphate or lithium manganate.

17. The electronic device according to claim 10, wherein the electrolyte further comprises an additive; and the additive comprises at least one of lithium difluoro(oxalato) borate, difluoropyridine, fluoroethylene carbonate, vinylene carbonate, lithium tetrafluoroborate, lithium difluorophosphate, succinonitrile, adipic dinitrile, or 1,3,6-hexanetricarbonitrile.

18. The electronic device according to claim 17, wherein based on the total mass of the electrolyte, a mass percentage of the additive is 0.1% to 10%.
